(19) United States
(12) Patent Application Publication
(10) Pub. No.: US 2022/0287295 A1
(43) Pub. Date: Sep. 15, 2022

(54) USE OF ANNELID HAEMOGLOBIN IN VITRO

(71) Applicant: HEMARINA, Morlaix (FR)

(72) Inventor: Franck ZAL, Ploujean-Morlaix (FR)

(21) Appl. No.: 17/636,188

(22) PCT Filed: Aug. 19, 2020
(86) PCT No.: PCT/EP2020/073154

§ 371 Date: Feb. 17, 2022

(30) Foreign Application Priority Data
Aug. 20, 2019 (FR) FR1909299

(51) Int. Cl. A01N 1/02

(52) U.S. Cl. CPC A01N 1/0226

(57) ABSTRACT

This invention relates to a method for analysing a sample of cells of a patient or an of an organoid, comprising:
a first step of mixing of cells of a patient or an of an organoid with at least one molecule chosen from an Annelid globin, an Annelid globin protomer and an extracellular Annelid haemoglobin,
optionally, a second step for preparation of the mixture obtained in the first step, and a third step of analysing the mixture obtained in the first step or in the second step.

This invention concerns the use of a molecule chosen from among an Annelid globin, an Annelid globin protomer and an Extracellular Annelid haemoglobin, for its use in vitro. In particular, this invention relates to a method for analysis of a sample of cells of a patient or a bacterial or an organoid sample, including:

a first step of mixing the sample of the patient's cells, bacterial or organoid sample with at least one molecule chosen from among an Annelid globin, an Annelid globin protomer and an extracellular Annelid haemoglobin,
optionally, a second step for preparation of the mixture obtained in the first step, and
a third step of analysis of the mixture obtained in the first step or the second step.

The medical biology examinations were conducted for the screening and follow-up of diseases. A biological examination was started by the extraction of a biological sample in a patient. This sample was then analysed to determine the normal value or the imbalance of a biological sample, and thus identify the nature, cause or the prognosis of a disease.

Among the different biological sample usable, the samples including the cells of a patient are particularly delicate. In fact, the preservation in good condition and/or survival of the cells extracted are crucial for the and sensitivity of the results which ensue as a result. The cells are a sensitive biological material; ill-adapted conditions of culture or storage can induce their death, which can have the effect of distorting the results of the analyses, or even making their analyses impossible.

However, the current medical biology techniques are not necessarily suitable to maintain an optimal survival of the cells.

It is an important part to obtain biological samples of good quality, drawn and prepared according to the quality standards (see the publication Ziv et al, The Importance of Biopsy in the Era of Molecular Medicine, Cancer J, 2016; 22(6): 418-422).

On the other part, the use of some solvents, particularly volatile organic solvents, poses problems for health and safety: for example, formaldehyde (or formalin) is a carcinogenic and highly volatile compound. During the preparation of a biological sample in view of its analysis, this solvent is to be handled with care.

Hence, there is a need for a method which enables to preserve the living cells extracted from a patient, as long as possible. This would enable to perform the analyses reliably, reproducibly and sensitively. In addition, this would enable to read and/or interpret the results with accuracy and under optimal conditions, because close to the in vivo context. Finally, there is a need for a method which restricts or does not use volatile organic solvent, and/or which substitutes the latter, in order to obtain safer experimentation environment.

Moreover, in the domain of in vitro tests, it is very common to use organoids as biological material mimicking the anatomy of an organ. Such structures have limited life-span, and the measures are not necessarily carried out in good conditions.

Thus, there is a need for a method which enables to preserve this type of biological material, in order to ensure reliable and reproducible measures.

Finally, in case of bacteria, it is very common to use cultures on agar to study these micro-organisms, for example to determine the efficiency level of new antibiotics, or even to identify a bacterial strain. Such cultures on agar are typically performed in the presence of blood, for example sheep blood (blood agar or Columbia agar with blood), in a relatively large quantity (of the order of 50 mL of blood per litre of agar). In addition, due to the presence of blood, such cultures cannot undergo a freezing step.

There is thus a need for a bacterial study method, which is more economic in raw materials, and which enables freezing of the samples.

This invention enables to respond to these expectations.

In fact, the objective of it is a method for analysis of a sample of cells of a preferably human patient, a bacterial or an organoid sample, comprising:

a first step of mixing the sample of the patient's cells, bacterial or organoid sample with at least one molecule chosen from among an Annelid globin, an Annelid globin protomer and an extracellular Annelid haemoglobin,
optionally, a second step for preparation of the mixture obtained in the first step, and a third step of analysis of the mixture obtained in the first step or the second step.

Such a method enables, due to the presence of at least one molecule chosen from among an Annelid globin, an Annelid globin protomer and an extracellular Annelid haemoglobin, to keep the cell or bacterial or organoid sample alive under good conditions.

In addition, the sample has a significantly improved life-span, which is of course dependent on the size of the sample, and the volume in which it is immersed.

Concerning the organoid, its life-span also improves, and enables reliable and reproducible measurements.

The method according to the invention has the advantage of being able to be implemented from the operating room where the sample of a patient, preferably a biopsy, is drawn, till the analysis laboratory: in fact, on extraction, the sample of the patient is mixed with at least one molecule chosen from among an Annelid globin, an Annelid globin protomer and an extracellular Annelid haemoglobin, then it undergoes the subsequent steps of the process intrinsically (for example, extractor hood in case of use of volatile organic solvent).

The object of this invention is also the use of a molecule chosen from among an Annelid globin, an Annelid globin protomer and an extracellular Annelid haemoglobin, for the storage of at least one sample of a preferably human patient's cells, a bacterial or an organoid sample.

The molecule according to the invention is chosen from among an Annelid globin, an Annelid globin protomer and an extracellular Annelid haemoglobin.

This molecule is an oxygen carrier. By “oxygen carrier”, we mean a molecule capable of transporting oxygen, reversibly, from the environment to the target cells, tissues or organs.

The extracellular Annelid haemoglobin is present in three classes of Annelids: Polychaetes, Oligochaetes and Achaetes. We talk of extracellular haemoglobin because it is not naturally contained in a cell, and can thus circulate freely in the blood system without chemical modification to stabilize it or make it functional.

The extracellular Annelid haemoglobin is a giant bipolymer of molecular weight lying between 2000 and 4000 kDa, composed of around 200 polypeptide chains lying between 4 and 12 different types that we generally collect into two categories.

The first category, numbering 144 to 192 elements, collects the polypeptide chains called “functional” which concern an active heme-type site, and are capable of binding the oxygen reversibly; these are globin type chains (in total eight types for the haemoglobin of Arenicola marina: a1, a2, b1, b2, b3, c, d1 and d2), whose masses lie between 15 and 18 kDa. They are very similar to the α and β type chains of vertebrae.

The second category, numbering 36 to 42 elements, collects the polypeptide chains called “structure” or “linkers” having little or no active site but enabling the assembly of subunits called twelfths or protomers. There are two types of linkers, L1 and L2.

Each haemoglobin molecule is composed of two superimposed hexagons which have been named hexagonal bilayer (hexagonal bilayer) and each hexagon is itself formed by the assembly of six sub-units (dodecamer or protomer) in the form of a drop of water. The native molecule is made up of twelve of these subunits (dodecamer or protomer). Each subunit has a molecular mass of approximately 250 kDa, and constitutes the functional unit of the native molecule.

Preferably, the extracellular Annelid haemoglobin is chosen from the extracellular haemoglobins of Annelids Polychaetes and the extracellular haemoglobins of Annelids Oligochaete. Preferably, the extracellular Annelid haemoglobin is chosen from the extracellular haemoglobins of the Lumbricidae family, the extracellular haemoglobins of the Arenicolidae family and the extracellular haemoglobins of the Nereididae family. Even more preferably, the extracellular Annelid haemoglobin is chosen from the extracellular haemoglobin of Lumbricus terrestris, the extracellular haemoglobin of Arenicola sp and the extracellular haemoglobin of Nereis sp, more preferably the extracellular haemoglobin of Arenicola marina or of Nereis virens. The Arenicola marina sandworm is a polychaete annelid worm living mainly in the sand.

According to the invention, the globin protomer of the extracellular Annelid haemoglobin constitutes the functional unit of the native haemoglobin, as indicated above. Finally, the globin chain of the extracellular Annelid haemoglobin can in particular be chosen from among the Ax and/or Bx type globin chains of extracellular Annelid haemoglobin.

The extracellular Annelid haemoglobin, its globin protomers and/or its globins do not require a cofactor to function, unlike mammalian, especially human haemoglobin. Finally, the extracellular Annelid haemoglobin, its globin protomers and/or its globins do not have blood typing, they enable avoiding any problem of immunological or allergic reaction. The Annelid extracellular haemoglobin, its globin protomers and/or its globins exhibit intrinsic superoxide dismutase (SOD) activity. As a result, this intrinsic antioxidant activity does not require any antioxidant to function, unlike the use of mammalian haemoglobin for which the antioxidant molecules are contained inside the red blood cell and are not bound to the haemoglobin. The extracellular Annelid haemoglobin, its globin protomers and/or its globins can be native or recombinant.

Preferably, the extracellular haemoglobin is that of Arenicola marina.

The method according to the invention consists of a first step of mixing of the sample of cells from the preferably human patient, the bacterial or organoid sample with at least one molecule chosen from among an Annelid globin, an Annelid globin protomer and an extracellular Annelid haemoglobin.

The sample of cells from the patient is any biological sample from the said patient comprising of cells. The cell sample can be a set of isolated cells, a fragment of biological tissue, or even an organ or an organ fragment. Cells can be eukaryotic or prokaryotic, preferably eukaryotic, preferably mammalian, preferably human.

This sample is preferably a set of isolated cells (such as for example a blood sample), a fragment of biological tissue, or even an organ fragment. This sample is preferably a blood sample, a biopsy, a smear or an organ resection.

A blood sample is preferably a sample including at least the red blood cells.

A biopsy is the extraction of a fragment of an organ or tissue, usually performed using a needle or a trocar.

A smear is a sample taken by scraping, usually using a swab, a small brush or a small spatula.

An organ resection, also called ablation, is the surgical removal of part of an organ or tissue, usually pathological.

The patient can be any vertebrate or invertebrate animal; preferably it is a mammal, preferably a human.

Preferably, the sample of cells from a preferably human patient, is a sample of a part of a pathological organ or tissue, in particular affected by cancer. Thus, preferably, the sample of cells from a patient is a sample of a part of an organ or tumor tissue.

The bacterial sample is any sample of bacteria, comprising of a single bacterial strain or a mixture of strains. Bacteria may or may not be known. Preferably, they are Gram+bacteria, preferably bacteria of the Bacilli class, preferably of the genus Streptococcus or Staphylococcus.

According to an alternative, the method according to the invention can also consist of a first step of mixing of the organoid with at least one molecule chosen from an Annelid globin, an Annelid globin protomer and an extracellular Annelid haemoglobin.

By “organoid”, we mean a three-dimensional structure which reproduces in vitro the micro-anatomy of an organ. Hence, an organoid corresponds to an organ model; it is prepared outside of any living organism. It is generally obtained by culture in the laboratory of one or more tissue precursor cells, such as stem cells (embryonic or induced pluripotent stem cell type). These cells can self-organise into three dimensions, in an adequate nutrient medium including growth and differentiation factors, to form the mini-organ. Preferably, the cells self-organise into a suitable three-dimensional environment, such as a hydrogel or a porous matrix.

The organoid used in this invention can be any organoid used in in vitro test, for example a reconstructed skin, a cerebral organoid, a tumour organoid, an intestinal or renal organoid. An organoid is hence distinct of the classical cells in culture (for example in Petri dishes); while the organoids are necessarily in three dimensions (3D), the cells in culture are only 2D.

Typically, the organoids maybe used to test the toxicity or the efficacy of potential drugs, or even to test the safety of cosmetic compositions.

According to the invention, preferably the globin, globin protomer or the extracellular Annelid haemoglobin used in the first step can be formulated in a buffer solution, a cellular culture medium or an organ or graft preservation solution.

The buffer solution creates an adequate saline environment for haemoglobin, its protomers and its globins, and thus allows the maintenance of the quaternary structure, and hence of the functionality of this molecule. Thanks to the buffer solution, the haemoglobin, its protomers and its globins are able to perform their oxygenation function.

According to the invention, the buffer solution is preferably an aqueous solution including salts, preferably chloride, sodium, calcium, magnesium and potassium ions, and according to the invention, confers to the composition a pH between 5 and 9, preferably between 5.5 and 8.5, between 6.5 and 7.6; its formulation is similar to that of the physiologically injectable liquid. Under these conditions, the extracellular Annelid haemoglobin, its globin protomers and its globins remain functional.

In this description, the pH is understood to be at room temperature (25° C.), unless mentioned otherwise. Preferably, the buffer solution is an aqueous solution comprising of sodium chloride, calcium chloride, magnesium chloride, potassium chloride, as well as sodium gluconate and sodium acetate, and has a pH between 6.5 and 7.6, preferably equal to 7.1±0.5, preferably around 7.35. More preferably, the buffer solution is an aqueous solution including 90 mM of NaCl, 23 Mm of Na-gluconate, 2.5 mM of CaCl₂), 27 mM of Na-acetate, 1.5 mM of MgCl₂, 5 mM of KCl, and has a pH of 7.1±0.5, which may contain between 0 and 100 mM of ascorbic acid and/or reduced glutathione type antioxidant.

Preferably, the globin, globin protomer or the extracellular Annelid haemoglobin used in the first step can also be formulated into an organ or graft preservation solution, or a cellular culture medium.

For example, the organ preservation solution may be an aqueous solution having a pH between 6.5 and 7.5, comprising of salts, preferably chloride, sulphate, sodium, calcium, magnesium and potassium ions; sugars, preferably mannitol, raffinose, sucrose, glucose, fructose, lactobionate (which is an impermeant), or gluconate; antioxidants, preferably glutathione; active agents, preferably xanthine oxidase inhibitors such as allopurinol, lactates, amino acids such as histidine, glutamic acid (or glutamate), tryptophan; and possibly colloids such as hydroxyethyl starch, polyethylene glycol or dextran.

The cellular culture media are available commercially and are very varied. For example, media available in Invitrogen, without being limited thereto are the following media: D-MEM, D-MEM/F-12, MEM, RPM 1640, medium 199 or any analogous medium.

Typically, the haemoglobin, its protomers or its globins are used in a concentration ranging from 0.03 g/L to 40 g/L, preferably from 0.05 g/L to 35 g/L, preferably from 0.1 g/L to 30 g/L, preferably from 0.5 g/L to 25 g/L, preferably from 1 g/L to 20 g/L. It can be used in a concentration ranging from 1.5 g/L to 20 g/L.

Preferably, the haemoglobin, its protomers or its globins are used in a concentration ranging from 0.03 g/L to 10 g/L, preferably from 0.08 g/L to 10 g/L, preferably from 0.1 g/L to 5 g/L.

The temperature for implementation of the method can be between 0° C. and 40° C., preferably between 2° C. and 39° C. This temperature is preferably around 4° C.; alternatively, this temperature is preferably around 37° C.

Preferably, the first step of the method according to the invention is carried out in a container including agar, Agar is a nutrient promoting or inhibiting (according to its composition) the proliferation and development of bacteria.

Typically, agar consists of at least a mixture of peptones, agar-agar and sodium chloride. Preferably, agar includes 5 to 35 g/L, preferably 7 to 30 g/L of peptones. Agar preferably includes 5 to 30 g/L, preferably from 7 to 25 g/L, preferably 10 to 20 g/L of agar-agar, Agar-agar enables to obtain a solid composition (solid gel), Agar preferably comprises of 3 to 20 g/L, preferably 4 to 10 g/L of sodium chloride.

According to the indications, agar can comprise other ingredients, for example, salts, starch, or any other conventional ingredient.

Preferably, agar comprises of at least one molecule chosen from an Annelid globin, an Annelid globin protomer and an extracellular Annelid haemoglobin.

Typically, blood agar is used, which comprises about 10 g/L of mammalian haemoglobin, for example sheep haemoglobin.

In the present invention, preferably, when the agar comprises of at least one molecule chosen from an Annelid globin, an Annelid globin protomer and an Annelid extracellular haemoglobin, the said haemoglobin, its protomers or its globins are used in a concentration ranging from 0.03 g/L to 5 g/L, preferably from 0.08 g/L to 3 g/L, preferably from 0.1 g/L to 2 g/L.

Preferably, the first step consists of depositing the sample of cells from the human patient, the bacterial or organoid sample in a container including agar and at least one molecule chosen from among an Annelid globin, an Annelid globin protomer and an extracellular Annelid haemoglobin.

Thus, according to this first step, the sample or the organoid is deposited in the agar container including at least one molecule chosen from among an Annelid globin, an Annelid globin protomer and an extracellular Annelid haemoglobin. The container obtained can be frozen while waiting to undergo other steps of the process, without compromising the reliability of the results obtained.

Hence at the end of the first step of the method, we obtain a mixture of haemoglobin, its protomers or its globins and cell sample, bacterial or organoid sample.

Optionally, a second step is present in the method: this second step comprises the preparation of there mixture obtained in the first step.

This second step preferably consists of at least the staining and/or thinning and/or incorporation in paraffin or an epoxy resin, of at least some cells and/or at least some cellular organelles of the sample.

By “cellular organelle” we mean a differentiated compartment contained in eukaryotic cells which has a given function. Preferably, the cell organelle is chosen from the nucleus, lysosomes, peroxisomes and mitochondria.

According to a first alternative, the second step directly consists of at least the staining and/or the thinning and/or the incorporation in paraffin or an epoxy resin of at least certain cells of the patient or bacterial sample.

According to a second alternative, the second step consists of the isolation of at least some cellular organelles of the patient's sample, then their staining and/or their thinning and/or their incorporation in paraffin or epoxy resin. For example, the second step can comprise the isolation of mitochondria from the cell sample of the patient, then their staining.

The biological tissues themselves have very little contrast in imaging. Typically, staining is used to increase contrast as well as to highlight a particular structure.

Staining can be performed with the help of a conventional dye, in particular an acidic or basic dye. Such a dye can be chosen from carmine, hematoxylin, eosin, picric acid, acid fuschin, basic fuschin, orange G, erythrosine, safranin, PAS staining (Periodic Acid Schiff), methylene blue and thionine.

The dye can also be Rhodamine 123. This dye is used particularly for staining of mitochondria.

The thinning of the sample can be performed by slicing, particularly with the help of a microtome, to make suitable slices.

This thinning is in particular carried out after incorporation of at least some cells of the sample in the paraffin or epoxy resin.

Typically, the mixture obtained in the first step is mixed with the paraffin in liquid state, or with an epoxy resin, then the resultant mixture is dried. Paraffin has the advantage of being liquid at a temperature higher than 56° C. and solidifies when the temperature passes below this limit. Finally, we obtain solid blocks of paraffin or of polymerised epoxy resin, containing the cells from the sample. These blocks can then be cut by a microtome to obtain fines slices of sample of a few micrometers in thickness. These slices can then undergo a staining, so as to identify certain elements more or less specifically, before being placed on a microscope slide for analysis.

Preferably, the sample of cells from the patient obtained in the first or second step is stored for a duration of few hours, for example at least 24 hours, preferably for at least 50 hours, preferably for at least 100 hours at a temperature lying between 0° C. and 10° C., for example 4° C.; or at a temperature lying between 15° C. et 25° C., such as the room temperature.

When an organoid is used, the second step of the method according to the invention, optional, comprises the preparation of the mixture obtained in the first step. This preparation can then comprise the contact of a compound with the mixture obtained in the first step.

The compound can be any potentially active molecule, or even a cosmetic composition. The molecule can be chemical or biological.

The method thus aims to determine the possible effects of the compound on the organoid. The second step can consist of at least the staining of some cells of the organoid at the least.

Finally, the method according to the invention consists of a third step of analysis of the mixture obtained in the first or the second step.

In particular, the third step consists of the analysis by histology, microscopy, by immunological detection or by molecular biology.

Histology is the technique of biological analysis comprising the identification of a set of given cells by chemical, enzymatic means, by radiography or by immunology.

Preferably, histology is chosen from among histochemistry, enzyme histochemistry, historadiography and immunohistochemistry.

We speak of histochemistry when at least some cells or organelles of the sample or of the organoid are stained through known chemical reactions between the laboratory reagents and the components of the cells studied (like cytoplasm, nucleus, or presence of carbohydrates).

Thus, the analysis by histochemistry is carried out when the second step comprises at least the staining of the sample or of the organoid.

Enzyme histochemistry is a histological method which enables the determination of the activity of one or more enzymes in a given tissue. The histoenzymological technique does not reveal the enzymes as such, but their presence through the product obtained during their action on a specific substrate of the enzyme in question.

Historadiography consists of making narrow slices of the tissue to be observed and for their incorporation in paraffin (i.e., second step of thinning and incorporation of the sample), then to observe them by using radiations.

Finally, immunohistochemistry consists of using antibodies to be fixed to a molecule present in at least some cells of the sample or of the organoid. These antibodies are specific for the molecule to be identified and hence the analysis to be performed. The antibody-antigen complexes (present in the sample) are then revealed by using a chemical compound.

Preferably, antibodies targeting the tumour antigens are used.

Microscopy can be an optical microscopy or a scanning electron microscopy.

Immunological detection relies on the same principle as immunohistochemistry, and uses antibodies to be fixed to a molecule present in at least some cells of the sample or of the organoid.

Preferably, immunological detection consists of using at least one antibody directed against a cancer antibody or an inflammatory antigen.

Molecular biology analysis may consist in particular of using PCR, or even the detection of a ratio of nucleic acids such as the DNA/RNA ratio, in particular by spectrophotometry. A high DNA/RNA ratio indicates a low quantity of RNA, thus a low cell life. Mixing of the sample patient's cells or organoid with at least one molecule chosen from an Annelid globin, an Annelid globin protomer and an extracellular Annelid haemoglobin according to the invention, enables, in particular, to protect the cellular RNA, and to thus obtain more reliable and reproducible results.

When an organoid is used, the third step of the method according to the invention may include the analysis by histology, by immunological detection or by molecular biology, particularly as indicated above.

The object of this invention is also a container including agar and at least one molecule chosen from among an Annelid globin, an Annelid globin protomer and an extracellular Annelid haemoglobin.

The agar preferably comprises of at least a mixture of peptones, agar-agar and sodium chloride. Preferably, the agar comprises of 5 to 35 g/L, preferably from 7 to 30 g/L of peptones. Preferably, the agar comprises of 5 to 30 g/L, preferably from 7 to 25 g/L, preferably from 10 to 20 g/L of agar-agar. Preferably, the agar comprises of 3 to 20 g/L, preferably from 4 to 10 g/L of sodium chloride.

The agar can also comprise other ingredients, for example salts, starch or any other conventional ingredient.

Preferably, haemoglobin, its protomers or its globins are used in a concentration ranging from 0.03 g/L to 5 g/L, preferably from 0.08 g/L to 3 g/L, preferably from 0.1 g/L to 2 g/L.

This container can be used for any in vitro test using a biological sample, for example a patient sample or a bacterial sample. It can be frozen without impacting the reliability of the results obtained.

This invention is illustrated by the following examples, not exhaustive.

### EXAMPLE 1: STUDY OF PRESERVATION OF DIFFERENT ORGANS OF RAT, BY MITOCHONDRIA ANALYSIS

The purpose of the study is to identify an optimal condition of storage of organs for the liver, heart and brain of rats.

The organs were stored at 4° C. in a solution of HEMO2Life® with modulation of the storage period and concentration of HEMO2Life®. The efficacy of the storage was evaluated by the characterisation of the mitochondrial integrity and functionality.

The main challenge of this study was to avoid the extemporaneous preparations of mitochondria by optimising the storage of samples during transportation.

HEMO2Life® is a composition consisting of extracellular haemoglobin of Arenicola marina, with different excipients.

### Materials and Methods

### Organs

The organs used are the liver, heart and brain of male Wistar rats of 250 g (reference: WI (Han), Charles River).

### Storage Conditions

### Duration:

Each organ was mixed with HEMO2Life® (first step of the process according to the invention).

A storage period of 24 hours was defined as point of reference. According to the results obtained at that time, the longest or shortest time points were evaluated with a modulation of the concentration of HEMO2Life®. In case of good storage for 24 hours (liver), a longer period was tested. In case of bad storage for 24 hours (heart and brain), as shorted period was tested.

### HEMO2Life® Solution:

HEMO2Life® (49 g/L mother-solution) was diluted in the stabilisation buffer to 20 g/L. The solution was diluted in the stabilisation buffer to obtain a final concentration of 15, 10 or 5 g/L in 8 mL (final volume).

### Container:

The containers are flat-base tubes of 20 ml (PP container, Dominique Dutscher). The volume of HEMO2Life® represents 40% of the total volume of the tube (8 mL).

### Stirring:

The containers were placed on an stirring apparatus (IKA HS 260 basic, VWR) at the speed of 90 revolutions/minute.

### Temperature:

The samples were stored in a cold chamber at 4° C.

The mitochondria were isolated from the organs by freezing, grinding, then density gradient centrifugation (second step of the method according to the invention), then incubated at 37° C. for 45 minutes. The integrity of the mitochondria was assessed by the absence of spontaneous swelling and by the transmembrane potential, and their functionality was assessed by the respiratory control index after incubation.

### Parameters

### Swelling and Transmembrane Potential:

The mitochondria were incubated at 37° C. with Rhodamine 123 in 96-well plates in 200 μL (final volume) (second step of the method according to the invention, staining step). The absorbance at 545 nm (swelling) and the fluorescence of Rhodamine 123 (loss of ΔΨm; λExcitation 485 nm; λEmission 535 nm) were recorded in real time for 45 minutes with the help of a spectrofluorometer (Tecan Infinite 200). Treatments of CaCl₂) (50 μM) and mCICCP (carbonyl cyanide m-chlorophenylhydrazone) (50 μM) were used as positive control for swelling and for loss of ΔΨm, respectively.

### Respiration:

The isolated mitochondria were incubated in a 1.5 mL cell under magnetic agitation with a Clark type oxygen electrode (Hansatech Instruments Ltd, Norfolk, United Kingdom), thermostated at 37° C., in 500 μL of a medium constituted from 0.3M of mannitol, phosphate buffer 10 mM (pH 7.3), KCl 10 mM, MgCl2 5 mM and 1 mg/ml of BSA (bovine serum albumin). The addition of ADP (1.65 mM) caused a sudden increase of the oxygen absorption when the ADP was converted into ATP, characterised by an active respiration state. The inhibitor Oligomycin A (1 μM), which blocks the respiration in the coupled mitochondria and the decoupling agent mCICCP were added to restore the activity.

### Calculations

### Swelling:

The swelling is calculated as follows (third step of the process according to the invention):

$$\% spontaneous swelling = 100 - [ 100 \times ( \frac{DOnegative control T 30 min}{DOnegative control T 0 min} ) ] \qquad [ Math 1 ]$$

### Transmembrane Potential:

The transmembrane potential is calculated as follows (third step of the process according to the invention):

$$\% loss of ΔΨ m = [ 100 \times ( \frac{RFUnegative control T 30 min}{RFUnegative control T 0 min} ) ] - 100 \qquad [ Math 2 ]$$

### Respiratory Control Index (RCI):

The respiratory control index is calculated as follows:

$$RCI = \frac{ClCCP slope}{Slope ( oligomycin )} \qquad [ Math 3 ]$$

This index indicates the impermeability of the oxidative phosphorylation, referring thus to the functionality of the respiratory chain and to the quality of the mitochondrial preparation.

### Acceptance Criteria

A preservation condition was validated for the liver and heart if:

Spontaneous swelling <20%

Spontaneous loss of ΔΨm<20%

RCI >3 (the RCI in the mitochondria isolated from fresh liver and heart was 6.34 and 4.85 respectively).

A preservation condition was validated for the brain if:

Spontaneous swelling <20%

Spontaneous loss of ΔΨm<20%

RCI >2 (the RCI in the mitochondria isolated from fresh brain was 3.23).

### Results

The results are summarized below.

The liver is the organ with the longest storage period (30 hrs) at 4° C. in HEMO2Life®. Beyond that, the mitochondrial membrane begins to rupture and respiratory activity decreases sharply. For the fresh liver, the respiratory control index (RCI) is 6.34, the spontaneous swelling is 5.40% and the spontaneous ΔΨm loss is 1.89%. After 24 hrs, the RCI value remained above 5, and spontaneous swelling and spontaneous ΔΨm loss were less than 10%, which suggested that mitochondrial functionality is strongly conserved. HEMO2Life® at 10 and 15 g/L maintains the mitochondrial functionality for 30 hrs of incubation at 4° C. It is interesting to note that the concentration of 10 g/L seems to better preserve respiratory activity (RCI=4.55 for 10 g/L and 3.59 for 15 g/L), while the concentration of 15 g/L seems to better preserve the integrity of the membrane (spontaneous swelling=17.86 for 10 g/L and 9.25 for 15 g/L). On the other hand, HEMO2Life® at 5 g/L seems too weak to ensure the mitochondrial integrity after 30 hrs at 4° C., as shown by high spontaneous swelling (>20%) revealing permeabilization of the mitochondrial membrane. A higher concentration (20 g/L) of HEMO2Life® seems to be deleterious for mitochondrial function, disrupting the activity of the respiratory chain. Irrespective of the concentration of HEMO2Life®, the mitochondrial functionality is not preserved beyond incubation for 30 hours at 4° C.

The functionality of cardiac mitochondria was preserved with an incubation for 24 hrs at 4° C. with 15 g/L of HEMO2Life®.

In fact, with a fresh heart, the RCI value was 4.85, the spontaneous swelling was 6.94% and the spontaneous ΔΨm loss was 7.81%. at the end of 16 hrs of incubation, 5 g/L of HEMO2Life® was not sufficient to preserve respiratory activity (RCI=2.71). However, the concentrations of 10 g/L (RCI=3.78) and 15 g/L (RCI=3.44) allowed maintenance of mitochondrial functionality at that precise moment. At 24 hours of incubation, only 15 g/L of HEMO2Life® enabled the mitochondrial functionality to be preserved (RCI>3). On the other hand, HEMO2Life® at 10 g/L was not sufficient (RCI=2.63) and the concentration of 20 g/L seemed too high to ensure good preservation (RCI=2.83). Beyond 24 h, mitochondrial functionality and heart integrity were not preserved.

The mitochondria isolated from fresh brain were less functional than mitochondria from liver and heart, as indicated by the value of RCI (RCI=3.23), while the integrity of these mitochondria was similar (spontaneous swelling=5.12% and spontaneous ΔΨm loss=5.39%). The mitochondrial functionality and integrity of the brain could be preserved with 12 hrs at 4° C. and 15 g/L of HEMO2Life® (RCI 2, swelling<12% and spontaneous ΔΨm loss <10%), whereas a 10 g/L dose was not sufficient (RCI=1.79). Beyond this period, the mitochondrial functionality and integrity were not conserved. Then, out of the conditions tested for the brain, HEMO2Life® at 15 g/L for 12 hrs is the most appropriate condition without damage on the mitochondrial membrane but a limited RCI.

To conclude, liver is the organ with the longest storage period in HEMO2Life® (30 hrs), followed by heart (24 hrs) then brain (12 hrs). For these periods, the concentration required in HEMO2Life® is 15 g/L for the heart and brain, and 10 g/L for the liver. The concentration of 10 g/L is protective for 16 hrs for the heart, while it does not preserve the brain for 12 hrs. An increase in HEMO2Life® concentration till 20 g/L is not protective, whatever may be the evaluated organ.

The method of analysis according to the invention enables to define the optimum conditions for the transportation of organs particularly of rats, such as liver, heart and brain, without any alteration of the mitochondria.

### EXAMPLE 2: STUDY OF BACTERIAL GROWTH ON AN AGAR SUBSTRATE

### Protocol:

Autoclaving of reconstituted agar in 1250 L equivalent (5×250 mL in 500 mL schott bottles) Post-autoclaving cooling in an oven at 52° C.

Bottle 1 (negative control): addition of 5 mL dilution solution (“stabilisation solution”, i.e. saline buffer of Arenicola marina haemoglobin) in 250 mL, then pouring of 12 boxes;

Bottle 2 (positive control): addition of hemoglobin of sheep at a concentration of 50 mL of blood per litre of agar, then pouring of 12 boxes;

Bottle 3 (invention): addition of diluted 5 mL Arenicola marina of haemoglobin (M101) in “stabilisation solution” (which is 0.5 mL at 50 g/L in 4.5 mL of “stabilisation solution”): final M101 at 0.1 g/L, then pouring of 12 boxes;

Bottle 4 (invention): addition of diluted 5 mL of M101 in “stabilisation solution” (which is 2.5 mL at 50 g/L dans 2.5 mL of “stabilisation solution”): final M101 at 0.5 g/L, then pouring of 12 boxes; and

Bottle 5 (invention): addition of 5 mL of M101 at 50 g/L (not diluted for having 1 g/L): final M101 at 1 g/L, then pouring of 12 boxes.

Out of the 12 boxes, 10 were inoculated with rake by addition of diluted S. aureus inoculum if necessary and homogenised, contained in 500 μL of “stabilisation solution” (first step of the invention method).

The target inoculum concentration was 50 cfu/box, or 100 cfu/mL.

2 boxes were used as negative control.

Incubation took place at 35° C.-37° C.

Then the number of colonies per box was read on the 10 boxes at 24 hrs, 48 hrs, 72 hrs and 96 hrs (third step of the invention process).

We checked the controls of each condition, at same time, which had to be negative.

### Results:

No difference in the time of growth was observed at 12 hrs, 24 hrs and 48 hrs.

### Conclusion:

The use of Arenicola marina haemoglobin at concentrations of 0.1, 0.5 and 1 g/L makes it possible to grow Staphylococcus aureus as on a Columbia type agar in fresh blood base. This Arenicola marina haemoglobin can be used with concentrations less than that of blood. Moreover, it can be frozen, which is not possible for blood.

1. A method for analyzing human patient cells, bacterial cells or an organoid sample, comprising
a first step of mixing the human patient cells, the bacterial cells or the organoid sample with at least one molecule chosen from among an Annelid globin, an Annelid globin protomer and an Annelid extracellular haemoglobin, and
optionally, a second step of preparing the mixture obtained in the first step, and a third step of analyzing the mixture obtained in the first step or in the second step.

2. The method according to claim 1, wherein the extracellular Annelid haemoglobin is an extracellular haemoglobins of Annelida Polychaete.

3. The method according to claim 1, wherein the extracellular Annelid haemoglobin is chosen from the extracellular haemoglobins of Arenicola marina and the extracellular haemoglobins of Nereis.

4. The method according to claim 1, wherein the human patient cells are from a blood sample, a biopsy, a smear or an organ resection sample.

5. The method according to claim 1, wherein the first step is carried out in a container containing agar.

6. The method according to claim 1, wherein the first step comprises depositing the human patient cells, the bacterial cells or the organoid sample in a container containing agar and at least one molecule chosen from among an Annelid globin, an Annelid globin protomer and an extracellular Annelid haemoglobin.

7. The method according to claim 1, wherein the third step of analyzing comprises analysis by histology, by microscopy, by immunological detection and/or by molecular biology.

8. The method according to claim 1, wherein the second step comprises at least staining and/or thinning and/or incorporating in paraffin or an epoxy resin, of at least some cells and/or of at least some cellular organelles of the human patient cells or the bacterial cells, or the staining of at least some cells of the organoid sample.

9. The method according to claim 1, wherein the second step comprises:
staining and/or thinning and/or incorporating in paraffin or an epoxy resin, of at least some cells of the human patient cells or the bacterial cells;
or isolating at least some cellular organelles from the human patient cells, then staining and/or thinning and/or incorporating the at least some cellular organelles in paraffin or epoxy resin;
or, in case of the organoid sample, contacting the mixture obtained in the first step with a compound.

10. The method according to claim 7, wherein the histology is chosen from histochemistry, enzyme histochemistry, historadiography and immunohistochemistry.

11. The method according to claim 7, wherein the immunological detection comprises using at least an antibody directed against a cancer antigen or an inflammatory antigen.

12. A method of preserving human patient cells, bacterial cells or an organoid sample, comprising
mixing cells from a human patient, the bacterial cells or the organoid sample with at least one molecule chosen from an Annelid globin, an Annelid globin protomer and an Annelid extracellular haemoglobin.

13. A container comprising agar and at least one molecule chosen from an Annelid globin, an Annelid globin protomer and an extracellular Annelid haemoglobin.

13. The method according to claim 2, wherein the extracellular Annelid haemoglobin is selected from the extracellular haemoglobins of the Arenicolidae family or the extracellular haemoglobins of the Nereididae family.

14. The container of claim 13, wherein the at least one molecule is present in a concentration ranging from 0.03 g/L to 5 g/L.

15. The container of claim 14, wherein the at least one molecule is present in a concentration ranging from 0.1 g/L to 2 g/L.
